(19) United States
(12) Patent Application Publication
(10) Pub. No.: US 2004/0094984 A1
(43) Pub. Date: May 20, 2004

(54) Motor vehicle luggage net that can be adapted to multiple attached states

(76) Inventor: Hiroyuki Eguchi, Nagoya-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/706,816

(22) Filed: Nov. 12, 2003

(30) Foreign Application Priority Data
Nov. 18, 2002 (JP) 2002-333312

(51) Int. Cl. B60R 7/00

(52) U.S. Cl. 296/37.1

(57) ABSTRACT

A luggage net includes a main construction that is substantially quadrilateral, fixed hems that hem two opposing edges of the main construction, and edge cords that pass through each of the meshes aligned along the other two opposing edges, both ends of the edge cords being secured by the fixed hems, and all of these constituent elements being composed of nonelastic material. Edge cord length adjustment means that allow adjustment of the effective length of the edge cords are attached to each edge cord. End cords are attached to each of the four corners of the luggage net, and a middle cord is provided between the two fixed hems, this middle cord passing through meshes of the main construction that are located along a line parallel to the two fixed hems, these constituent elements being composed of elastic cords and the ends of each being provided with connectors that can connect to the motor vehicle.

### BACKGROUND OF THE INVENTION

1. Field of the Invention

The present invention relates to a luggage net for securing luggage in the luggage-storing compartment of a motor vehicle.

2. Description of the Related Art

As an example of a means of storing luggage in a motor vehicle, and in particular, in a passenger automobile, the rear portion of the interior of the motor vehicle is established as the luggage-storing compartment, and relatively large pieces of luggage may be stowed in this portion. In such cases, however, the potential movement of the luggage within the interior of the motor vehicle that accompanies operation of the motor vehicle may not only cause damage to the luggage or the interior of the motor vehicle, but may also pose a danger to passengers inside the motor vehicle. As a result, there are examples in which an elastic net is extended between the side walls or across the floor of the motor vehicle as a receptacle for restraining movement of luggage that has been placed in the rear portion of the interior of a motor vehicle during operation of the motor vehicle.

A representative example of this type of net is described in the specification of Japanese Patent No. 2847172 (U.S. Pat. No. 5,340,004). In this example, net 50 is attached in a perpendicular direction to the floor of a motor vehicle, as shown in FIG. 1. In this state, net 50 has a front side and a rear side and can be opened and closed at its upper end, and luggage 51 can be accommodated between this front side and rear side. Elastic elements are provided along the upper edges of the front side and rear side, and when net 50 is in its attached state, the elastic elements are stretched from side to side and thus placed in a mutually contacting state that prevents luggage 51 from escaping from the receptacle. In the specification of the above-cited patent, luggage that is accommodated within the receptacle is prevented by this construction from shifting in any direction beyond a prescribed range. In addition, a net that is vertically attached in this way is also disclosed in Japanese Patent No. 3264124.

Alternatively, a type of net has also been proposed in which the net is attached along the floor whereby luggage can be secured by pressure against the floor surface. Such a net is disclosed in the specification of Japanese Patent No. 3254979. In this example, rope hooks 61 are provided that can be caused to protrude above the floor surface as shown in FIG. 2. Net 60 is attached by connecting the four corners of net 60 to these rope hooks 61 along the floor surface by means of S-shaped hooks. In this example, additional rope hooks 62 are further provided at the edges of the luggage-storing compartment, and net 60 can therefore be attached along the wall of the luggage-storing compartment by connecting to these rope hooks 62.

When luggage is stowed in the rear of the interior of the motor vehicle, the accommodation of luggage having different sizes, weights, and shapes should be considered depending on the situation. The construction that is disclosed in Japanese Patent No. 2847172 cannot physically accommodate luggage that is larger than a fixed size inside net 50, and net 50 may not be able to support the weight of luggage when the luggage that is to be accommodated is heavier than a prescribed weight.

In such cases, a construction as described in the specification of the above-described Japanese Patent No. 3254979 that allows net 60 to be attached in a plurality of attached states is preferable because a variety of luggage can be securely accommodated, and further, can be considered to be more convenient for the user.

Nevertheless, when net 60 of the construction described in the specification of Japanese Patent No. 3254979 was actually attached in a variety of motor vehicles, difficulty was encountered in attaching the net in a plurality of states when net 60 of the same size was used. In other words, the preferable size of the net when attaching horizontally along the floor generally differs from the preferable size when attaching along the wall of the luggage compartment perpendicularly to the floor. A large net may be used to deal with either attached state, but when a smaller net is preferably used in such a case, the net will sag. On the other hand, a smaller net may be used to serve both purposes, but when the use of a larger net is preferable, the net will be unable to cover the luggage, or will impose a limitation on the luggage that can be accommodated.

### SUMMARY OF THE INVENTION

The present invention was realized in view of the problems of the above-described prior art and has as an object the provision of a motor vehicle luggage net that can be attached in a variety of states, and that can, in each state, expand to the preferred adequate size that is required with a degree of tension that is suitable for that state.

The motor vehicle luggage net of the present invention that can achieve the above-described object has a main construction that is substantially quadrilateral, that is composed of nonelastic cords, and that is formed as a mesh. Two opposing edges of the main construction are hemmed by fixed hems. In the two other opposing edges of the main construction that are not provided with the fixed hems, nonelastic edge cords are attached that pass through each of the meshes that are aligned along each edge of the main construction. An edge cord length adjustment means that can retain a portion of the edge cord is attached to each edge cord, these edge cord length adjustment means being capable of adjusting the effective length of the edge cords through variation of the amount of edge cord that is retained.

This construction enables adjustment of the length of the motor vehicle luggage net along the edges of the luggage net through the use of the edge cord length adjustment means to adjust the effective length of the edge cords along the edges of the main construction of the motor vehicle luggage net. Here, the edge cords merely pass through the main construction of the motor vehicle luggage net and are not fixed to the main construction, and the main construction of the motor vehicle luggage net is therefore able to expand or contract with each mesh expanding or contracting substantially evenly and with the main construction free of uneven expansion or contraction in portions. This construction therefore allows natural expansion or contraction of the motor vehicle luggage net without disorder of the motor vehicle luggage net, and further, allows adjustment of the luggage net to lengths that are appropriate to a variety of attached states.

In addition, because the main construction is composed of cord that in nonelastic, this construction offers the advantages of both enabling a relatively easy increase in the strength of the main construction, and further, of facilitating compact folding of the luggage net when not in use.

End cords that are composed of elastic cords are preferably attached to both ends of each of the fixed hems of the motor vehicle luggage net of the present invention, and the ends of these end cords are provided with connectors that can connect to connectors of the motor vehicle. The provision of these end cords can facilitate attachment to the luggage compartment of the motor vehicle. In addition, forming the end cords of elastic cords enables attachment of the motor vehicle luggage net with an ideal degree of tension.

In addition, a middle cord is preferably provided at a position between the two fixed hems, this middle cord passing through each of the meshes that are located along a line that is parallel to the fixed hems of the main construction of the motor vehicle luggage net, and both ends of this middle cord are provided with connectors that can connect to connectors of the motor vehicle. The provision of this type of middle cord allows the motor vehicle luggage net to be folded in half and then attached with the end cords and middle cord each connected to respective connectors of the motor vehicle. The entire luggage net can therefore be extended when the area over which the luggage net is stretched is relatively large, but folded in half when the area over which the luggage net is stretched is relatively small; and in either case, the luggage net can be effectively stretched over when the motor vehicle luggage net is attached in states having a wide variation in the stretch area.

The middle cord is preferably composed of elastic cord, whereby the motor vehicle luggage net can be attached with an appropriate degree of tension when the middle cord is used as a connector. Further, if a plurality of connectors are provided at each of the ends of the middle cord along the longitudinal direction of the middle cord, one of the plurality of connectors can be selectively used to connect with the motor vehicle according to the state of attachment, whereby the degree of tension can be adjusted to more effectively attach the motor vehicle luggage net in each attached state.

By means of the above-described construction, the motor vehicle luggage net of the present invention can be extended to the preferable size required for a variety of attached states and with a degree of tension that is appropriate to each state, and can be used in an attachment method in which the same motor vehicle luggage net is used interchangeably in a plurality of attached states. A specific attachment method that can serve as one preferable example is an attachment method in which first to third attached states are interchangeably adopted. In this case, the first attached state is an attached state in which the motor vehicle luggage net is spread along the floor of the motor vehicle with each end cord connected to a respective connector in the motor vehicle interior. The second attached state is a state of attachment in which the motor vehicle luggage net is folded in half along the position of the middle cord and attached vertically upright with the end cords connected to side-wall connectors of the motor vehicle and the connectors at both ends of the middle cord connected to connectors that are provided at positions in the vicinity of the floor that are positioned perpendicularly below the connectors to which the end cords are connected. The third attached state is a state of attachment in which the motor vehicle luggage net is folded in half along the position of the middle cord and attached upright with a forward inclination with the end cords connected to connectors in the side walls of the motor vehicle and connectors at both ends of the middle cord connected to connectors that are provided at positions in the vicinity of the floor of the motor vehicle that are located toward the rear of the motor vehicle from positions that are perpendicularly below the connectors to which the end cords are connected.

In the first attached state, a relatively large piece of luggage that can be loaded on the floor can be effectively restrained against the floor by the pressure exerted by the motor vehicle luggage net. In the second attached state, a relatively small piece of luggage or a piece of luggage that is difficult to load with stability can be effectively restrained by being held between the folded halves of the motor vehicle luggage net. In the third attached state, a piece of luggage that has been placed on the floor with poor stability can be gently restrained from moving toward the rear of the motor vehicle by the acceleration of the motor vehicle, whereby impacts to the piece of luggage or the interior of the motor vehicle can be prevented.

Finally, in this attachment method, the distance between the connectors of the motor vehicle for connecting with the end cords and the connectors for connecting with the middle cord may differ for the second attached state and the third attached state. In this case, a middle cord may be used in which a plurality of connectors is provided along the longitudinal direction at each end of the middle cord. Thus, in each attached state, one of the plurality of connectors of the middle cord can be selectively used for connection to easily set the degree of tension of the motor vehicle luggage net to the proper degree of tension that is appropriate for each attached state.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a perspective view showing a prior-art example of a net for stowing luggage in the luggage compartment of a motor vehicle;

FIG. 2 is a perspective view showing another prior-art example of a net for stowing luggage in the luggage compartment of a motor vehicle;

FIG. 3 is a plan view of a luggage net of an embodiment of the present invention;

FIG. 4 is an enlarged view of section A of FIG. 1;

FIG. 5 is an enlarged view of section B of FIG. 1;

FIG. 6 is a perspective view showing the first attached state in which the luggage net of FIG. 1 is attached in the luggage compartment of a motor vehicle.

FIG. 7 is a perspective view showing the second attached state in which the luggage net of FIG. 1 is attached in the luggage compartment of a motor vehicle; and

FIG. 8 is a perspective view showing the third attached state in which the luggage net of FIG. 1 is attached in the luggage compartment of a motor vehicle.

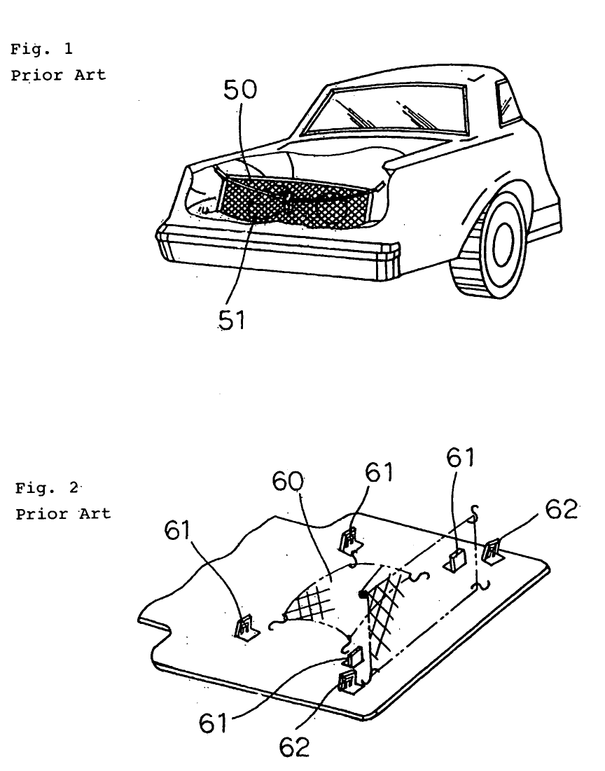

### DETAILED DESCRIPTION OF THE PREFERRED EMBODIMENTS

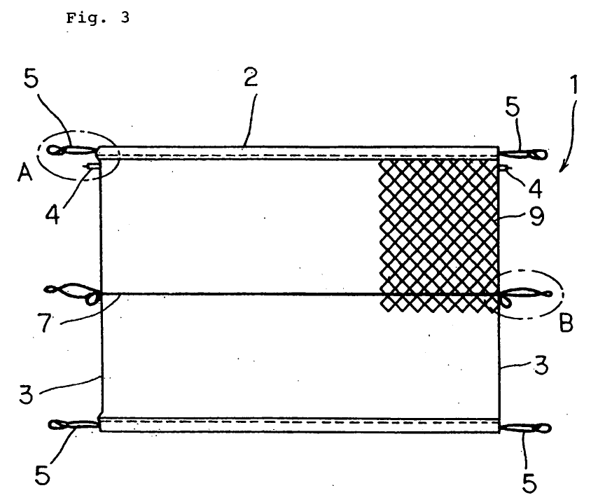

The construction of luggage net 1 of the present embodiment is first explained with reference to FIGS. 3-5.

Luggage net 1 includes main construction 9 that is quadrilateral in overall shape and that is formed as a mesh composed of nonelastic cords. Two opposing edges of main construction 9 are each hemmed by nonelastic fixed hems 2. The other two opposing edges of main construction 9 are each provided with nonelastic edge cord 3 that passes through each mesh that lines the respective edge.

As will be explained hereinbelow, this luggage net 1 is attached such that the longitudinal direction of fixed hems 2 is parallel to the direction of width of the motor vehicle, and the length in this direction is therefore suitably slightly less than the width of the part of the motor vehicle in which luggage net 1 is to be attached. The length of the direction that is perpendicular to the longitudinal direction of fixed hem 2 is suitably slightly shorter than twice the height of the part of the motor vehicle in which this luggage net 1 is to be attached.

In a preferable example, luggage net 1 is formed by weaving together, for example, polyester cords in which nonelastic threads are thickly (preferably on the order of 10,000 denier) intertwined. Regarding the size of the mesh of luggage net 1, the inner diameter suitably ranges from about 10-50 mm, and the shape of the mesh is suitably quadrilateral or a shape that is nearly quadrilateral.

As fixed hem 2, a fabric is preferably used that is about 50 mm wide and that is formed by weaving a strong fiber such as polyester thread with an elastic fiber such as polyurethane thread, this fabric being folded in half with the end of main construction 9 interposed and then attached by stitching from outside. Edging main construction 9 with fixed hems 2 in this way prevents unraveling of main construction 9, improves the appearance, and, to a certain degree, enables luggage net 1 to maintain an extended state in the direction that fixed hem 2 extends without exerting force.

As edge cords 3, a cord is suitably used that is slightly thicker (having a diameter of up to 5 mm) than the cords that make up main construction 9. These edge cords 3 pass through each mesh on the outermost edge on both side edges of luggage net 1. Edge cord length adjustment means 4 is attached to edge cord 3, and this edge cord length adjustment means 4 holds a middle portion of edge cord 3 in a doubled state, enables adjustment of the held position, and enables adjustment of the effective length of edge cord 3 along the edge of luggage net 1.

A known cord adjuster can be used as edge cord length adjustment means 4. Using this edge cord length adjustment means 4 to adjust the effective length of edge cord 3 enables adjustment of the effective length of luggage net 1 in the direction along edge cord 3. Here, edge cord 3 merely passes through the meshes of main construction 9 and is not secured to main construction 9, and as a result, changing the length of edge cord 3 enables expansion or contraction of luggage net 1 such that the expansion and contraction of the effective length of each of the meshes is substantially equivalent.

In other words, edge cord 3 is pulled to extend the length of edge cord 3 that is held by edge cord length adjustment means 4 and thus shorten the effective length of edge cord 3, and each part of main construction 9 that is hitched by edge cord 3 slides as necessary along edge cord 3. As a result, uneven contraction in portions of main construction 9 and the formation of wrinkles in main construction 9 can be avoided. Conversely, when the lock of edge cord length adjustment means 4 is opened to release edge cord 3 and extend the effective length of edge cord 3, each mesh extends evenly, whereby uneven extension in parts of luggage net 1 can be avoided and luggage net 1 can be restored to its natural extended state. This even expansion and contraction of the meshes can improve the appearance when luggage net 1 is stretched, and moreover, can prevent luggage from poking through the meshes.

This type of edge cord length adjustment means 4 should be provided symmetrically one per side in the two opposing edge cords 3. Such a construction enables equal adjustment of the length of the edges on both sides of luggage net 1 and enables natural adjustment of the overall length of luggage net 1.

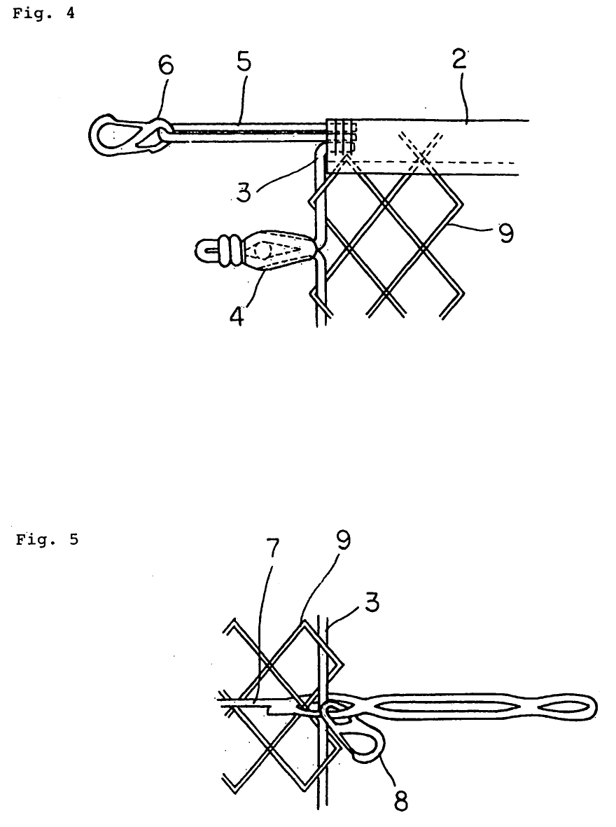

As will be explained hereinbelow, luggage net 1 is used by attaching to the interior of a motor vehicle, and as a result, means for connecting to the motor vehicle are attached to each corner of luggage net 1. In the present embodiment, as a preferable example, end cords 5 having an overall rubber elasticity are secured to the four corners of fixed hems 2, and these end cords 5 are used as connection means. As can be clearly understood from FIG. 4, end cords 5 are doubled with the edges of both ends aligned and secured by stitching at the end of fixed hem 2, and the overall shape of each of end cords 5 is therefore a loop. A construction in which these loops connect to the motor vehicle is possible, but in the example shown in the figure, hooks 6 for connection are passed through these loops and thus attached to end cords 5. The use of this type of hook 6 facilitates the operation of connecting to the motor vehicle, and further, enables a more secure connection.

Although not clearly shown in the figure, this hook 6 can be constituted, as necessary, with gaps provided in a portion of the ring through which end cord 5 is inserted and in a portion of the ring that is on the opposite end of hook 6 such that the rings can be flexibly deformed to allow opening and closing of the rings, whereby the ease of the operations of connecting and disconnecting can be improved.

A bungee cord in which a rubber cord is covered by woven polyester threads or the like to improve durability is ideal for use as end cord 5, and the length of end cord 5 in its doubled-over state is suitably on the order of 60-100 mm. A resin material is suitable for use as hook 6.

Between the two fixed hems 2 of luggage net 1, middle cord 7 is provided that crosses the net parallel to fixed hems 2 and that passes through the meshes of main construction 9. An elastic cord having overall rubber elasticity is ideal, and the same type of bungee cord as used for end cords 5 may be used. As can be clearly understood from FIG. 5, middle cord 7 is attached by passing through each of a series of meshes of luggage net 1 that are located along a line parallel to fixed hems 2, and loops that encircle edge cords 3 are formed on the two ends of middle cord 7, whereby middle cord 7 is loosely secured to luggage net 1.

As will be explained hereinbelow, this middle cord 7 is used to connect to the motor vehicle when luggage net 1 installed folded in half, and for this purpose, connection means are provided at both ends of middle cord 7. These connection means are preferably constructed as variable connection means that allow connection to different positions inside the motor vehicle and, in particular, to positions of varying distance from the portion of middle cord 7 that is attached to edge cord 3, such that the degree of the tension of middle cord 7 does not vary greatly when luggage net 1 is installed. In the present embodiment, a plurality of loops is formed as a preferable example of this type of variable connection means. Specifically, in the example that is shown in the figure, three loops are formed including the loop that encircles edge cord 3, which is closest to main construction 9 of luggage net 1. One loop of this plurality of loops is selectively used to connect to the motor vehicle, whereby the degree of tension of middle cord 7 can be made substantially uniform and set to an appropriate degree of tension even when connecting to different positions inside the motor vehicle, thus allowing adjustment of the degree of tension of luggage net 1 as necessary.

This plurality of loops are formed by forming the two ends of middle cord 7 in the lengths, in which middle cord 7 extends beyond main construction 9, folding back each end of middle cord 7, and stitching middle cord 7 together at a plurality of locations (in this example, three locations). The length of the portion of middle cord 7 that is folded back is preferably on the order of 100-150 mm. Hook 8 for connection may be attached by inserting hook 8 into any one of the plurality of loops thus formed. Each of hooks 8 are preferably formed of resin, and preferably can be attached to different loops according to the position of attaching luggage net 1.

As with hooks 6, these hooks 8 can be formed with gaps provided as necessary in a portion of the ring through which middle cord 7 passes and the ring on the opposite end of hook 8 such that the rings can be flexibly deformed to open and close the rings, thus enabling an improvement in the ease of connecting and disconnecting.

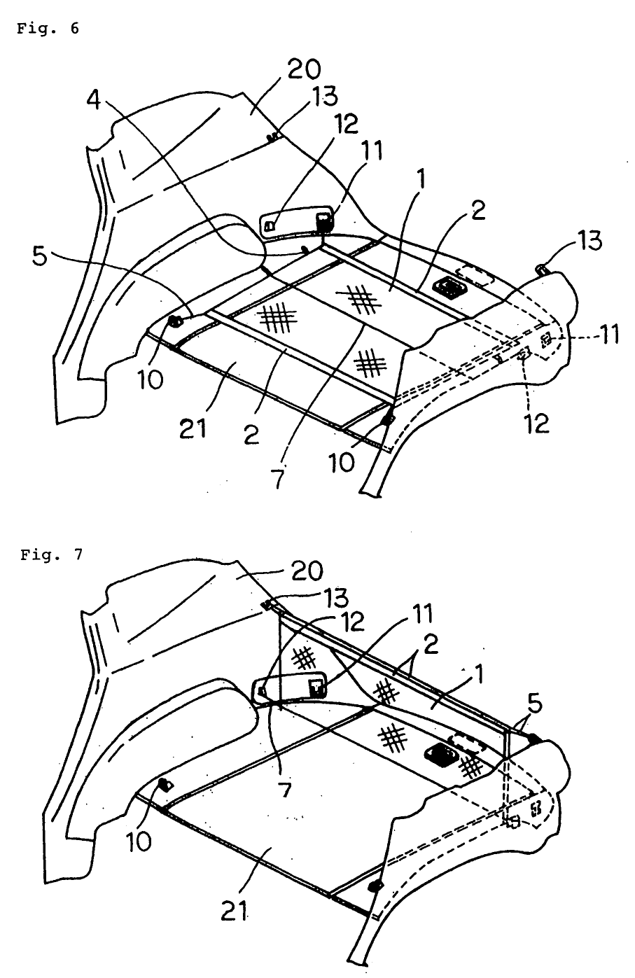

An example of the attachment method for attaching the above-described luggage net 1 in the rear of a hatchback automobile is next explained with reference to FIGS. 6-8. In the attachment method of the present embodiment, each of the attached states that are shown in FIGS. 6-8 is interchangeable adopted by varying the attachment of the same luggage net 1. In each figure, the left side corresponds to the front of the automobile, and, although not shown in the figures, the backrest of the rear seat of the automobile or a panel for dividing the passenger section from luggage compartment is located at the left side of each figure, while the hatchback door of the automobile is located on the right side.

Connectors are provided at a plurality of positions inside the automobile, i.e., hooks 10, 11, 12, and 13 are each provided on both the right and left sides, hooks 10 being provided in the front end of floor 21, hooks 11 being provided in the vicinity of the lower rear of side wall 20, hooks 12 being provided at a position that is slightly forward of hooks 11, and hooks 13 being provided at a position that is directly above hooks 12. These hooks 10, 11, 12, and 13 may be any connector that can connect to previously described hooks 6 and 8 and/or the loops of end cord 5 or middle cord 7, and, for example, may be the rope hooks that are described in Japanese Patent No. 3254979.

In the first attached state that is shown in FIG. 6, luggage net 1 is attached spread out along floor 21, with end cords 5 of the four corners or hooks 6 that are attached to these end cords 5 being connected to corresponding hooks 10 and 11 of the motor vehicle. Attaching luggage net 1 in this way allows the luggage to be secured by pressure against floor 21 of the motor vehicle. Here, the user uses edge cord length adjustment means 4 to adjust the length of luggage net 1 according to the size of the luggage, whereby end cords 5 can be extended and placed in the appropriate state of tension. The luggage is thus pressed toward floor 21 under a proper degree of force and movement of the luggage that accompanies operation of the motor vehicle can be adequately restrained. This attached state is therefore appropriate for securing relatively large pieces of luggage that can be placed on floor 21.

Next, in the second attached state that is shown in FIG. 7, luggage net 1 is folded into halves along middle cord 7 such that one of fixed hems 2 of the two sides overlies the other, end cords 5 are each connected to hooks 13, and the two ends of middle cord 7 are connected to hooks 12, whereby luggage net 1 is attached in a substantially vertical and upright state. Here, in the example that is shown in FIG. 7, two end cords 5 of overlapping fixed hems 2 on each side are connected to the same hook 13.

In this attached state, luggage can be inserted and held between the two halves of luggage net 1 that has been folded in half. Here, luggage net 1 can be placed in a state in which adequate tension is applied from the elastic force of middle cord 7 and end cords 5. In the state in which luggage is not inserted, the opposing halves of folded main construction 9 can be caused to contact each other with a proper amount of force generated in the direction of mutual contact. Thus, when luggage is inserted between the opposing halves of luggage net 1, pressure can be applied to the luggage from both sides by main construction 9 of luggage net 1. As a result, even a relatively small piece of luggage can be reliably held and prevented from escaping from between the opposing halves of luggage net 1 due to acceleration or vibration that accompanies operation of the motor vehicle. Accordingly, this attached state is appropriate for securing relatively small pieces of luggage or luggage that is difficult to place stably on floor 21, and accordingly, luggage that is difficult to secure in the first attached state.

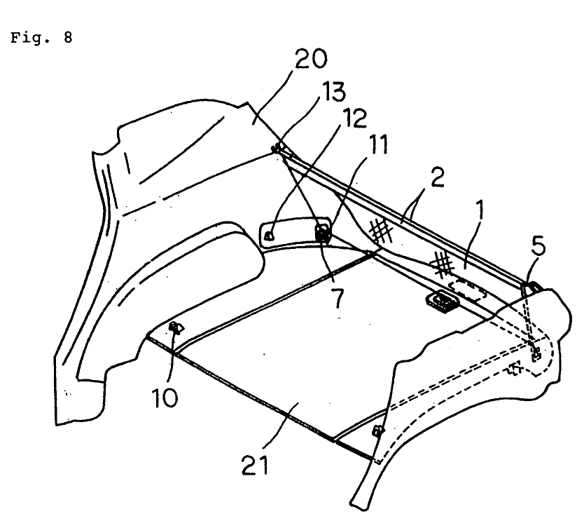

Next, in the third attached state that is shown in FIG. 8, luggage net 1 is folded in half as in the second attached state but attached upright with an inclination toward the front of the motor vehicle. In other words, in this state, end cords 5 of overlapping fixed hems 2 are connected to hooks 13 that are provided in the upper portion of side walls 20 as in the second attached state, but middle cord 7 is connected to hooks 11 that are provided toward the rear rather than to hooks 12 that are provided perpendicularly below hooks 13.

In this attached state, instead of directly securing luggage by means of luggage net 1, luggage having poor stability that is placed forward of luggage net 1 can be gently restrained from moving toward the rear of the motor vehicle due to acceleration or vibration that accompany operation of the motor vehicle. This arrangement can prevent shocks to the luggage and the inner walls of the motor vehicle even when movement of luggage occurs. Here, luggage net 1 is attached with an inclination toward floor 21, and as a result, when luggage strikes against luggage net 1, the sudden concentrated application of pressure against luggage net 1 can be suppressed and the luggage that strikes against luggage net 1 is forced downward by luggage net 1, whereby the luggage can be restrained from flying up and can be gently but effectively slowed down.

In the second attached state and third attached state, although end cords 5 of luggage net 1 are connected to the same hooks 13, middle cord 7 is connected to hooks 12 in the second attached state and to hooks 11 in the third attached state, and the distance is therefore different from the portion of middle cord 7 that is attached to main construction 9 to the portions at which the ends of middle cord 7 connect to hooks 12 or 11. As previously explained, the ends of middle cord 7 are each realized as a variable connection means in which a plurality of loops are formed, and consequently, the degree of tension of luggage net 1 can be made substantially the same for the second attached state and third attached state despite this difference in distance. In other words, for example, the loop of middle cord 7 that is closest to main construction 9 is used for connection in the second attached state in which the distance to the connectors is shorter, and the loop that is distant from main construction 9 is used for connection in the third attached state in which the distance to the connector is longer, whereby the difference in distance can be absorbed and the degree of tension can be equalized.

Further, the degree of tension of luggage net 1 can be set appropriately according to each attached state by setting the position of each loop of middle cord 7. For example, in the present embodiment, a relatively high degree of tension of luggage net 1 is preferable in order to firmly hold luggage between the doubled halves of luggage net 1 in the second attachment stage, and the position of the innermost loop of middle cord 7 can therefore be chosen in order to produce a relatively strong degree of tension. On the other hand, a relatively low degree oft tension is preferably produced in luggage net 1 in order to gently decelerate luggage that collides with luggage net 1 in the third attached state, and the position of the outermost loop of middle cord 7 can be set to produce this relatively weak degree of tension.

As described hereinabove, luggage net 1 of the present embodiment can be attached in the attached state of the three attached states that is appropriate for the luggage that is to be accommodated, and the attachment of luggage net 1 can be easily switched to use these different attached states. Here, luggage net 1 can be stretched over the necessary area and attached by using edge cord length adjustment means 4 to adjust the effective length of luggage net 1 or using the variable connection means at the ends of middle cord 7 to produce the appropriate degree of tension in luggage net 1 in each of the attached states. In addition, luggage net 1 is attached in a fully extended state when it is stretched generally horizontally as in the first attached state, and is attached folded in half as two layers when it is attached generally perpendicularly as in the second attached state or when attached generally upright but inclined as in the third attached state; and luggage net 1 can therefore be naturally extended to the preferable size as necessary for each state despite the wide variation in the preferable extended area.

In addition, the cords that make up main construction 9, fixed hems 2, and edge cords 3 of luggage net 1 of the present embodiment are formed from a nonelastic material, and the overall strength of luggage net 1 can therefore be increased with comparative ease, and luggage net 1 can therefore be constructed to hold relatively heavy luggage. Further, since these principal constituent elements are non-elastic materials, the net is not prone to assuming the form of a rounded heap when it is disconnected, as is the case when elastic materials are used, and luggage net 1 can therefore be folded up in a thin and compact form and stored when not in use. In this case, because its overall form is substantially quadrilateral, luggage net 1 can be easily and properly folded.

Finally, in luggage net 1 of the present embodiment, elastic parts are used for end cords 5 for connection and middle cord 7, edge cord length adjustment means 4 can be used to adjust the effective length of luggage net 1, and further, the ends of middle cord 7 serve as variable connection means, and as a result, the same luggage net can be used in each of a variety of types of motor vehicles as long as there is not a great difference in the size of the luggage compartment, and the degree of tension of luggage net 1 can be made properly adjustable regardless of the type of vehicle.

While preferred embodiments of the present invention have been described using specific terms, such description is for illustrative purposes only, and it is to be understood that changes and variations may be made without departing from the spirit or scope of the following claims.

What is claimed is:

1. A motor vehicle luggage net for holding luggage in the luggage compartment of a motor vehicle, comprising:
a main construction that is substantially quadrilateral, that is composed of nonelastic cords, and that is formed as a mesh;
fixed hems that hem two opposing edges of said main construction;
nonelastic edge cords that pass through each of meshes that are aligned along each of the other two opposing edges of said main construction that are not provided with said fixed hems, the two ends of each edge cord being secured to said fixed hems; and
edge cord length adjustment means attached to each of said edge cords for retaining a portion of said edge cord, these edge cord length adjustment means being capable of adjusting the effective length of said edge cords through variation of the amount of said edge cord that is retained.

2. A motor vehicle luggage net according to claim 1, further comprising:
end cords that are composed of elastic cords that are attached to the two ends of each of said fixed hems, the ends of said end cords being provided with connectors that can connect to connectors of said motor vehicle.

3. A motor vehicle luggage net according to claim 1, further comprising:
a middle cord that is provided at a position between said two fixed hems and that passes through each of the meshes that are located along a line parallel to said fixed hems, the two ends of said middle cord being provided with connectors that can connect to connectors of said motor vehicle.

4. A motor vehicle luggage net according to claim 3, wherein said middle cord is composed of elastic cord.

5. A motor vehicle luggage net according to claim 3, wherein a plurality of said connectors of said middle cord are provided along the longitudinal direction of said middle cord at each end of said middle cord.

6. A motor vehicle luggage net attachment method for attaching a motor vehicle luggage net for holding luggage in the storage compartment of a motor vehicle, said motor vehicle luggage net comprising:
a main construction that is substantially quadrilateral, that is composed of nonelastic cords, and that is formed as a mesh;
fixed hems that hem two opposing edges of said main construction;
nonelastic edge cords that pass through each of meshes that are aligned along each of the other two opposing edges of said main construction that are not provided with said fixed hems, the two ends of each edge cord being secured to said fixed hems;
edge cord length adjustment means attached to each of said edge cords for retaining a portion of said edge cord, these edge cord length adjustment means being capable of adjusting the effective length of said edge cords through variation of the amount of said edge cord that is retained;
end cords that are composed of elastic cords and that are attached to the two ends of each of said fixed hems, the ends of said end cords being provided with connectors that can connect to connectors of said motor vehicle; and
a middle cord that is provided at a position between said two fixed hems and that passes through each of meshes that are located along a line parallel to said fixed hems, the two ends of said middle cord being provided with connectors that can connect to connectors of said motor vehicle;
wherein a single said motor vehicle luggage net is interchangeably positioned in one of:
a first attached state in which said motor vehicle luggage net is attached extended along the floor of said motor vehicle with each of said end cords connected to a respective connector of said motor vehicle;
a second attached state in which said motor vehicle luggage net is folded in half along the position of said middle cord and attached vertically upright with said end cords connected to connectors in the side walls of said motor vehicle and said connectors at the two ends of said middle cord connected to connectors that are provided at positions in the vicinity of the floor of said motor vehicle at positions that are perpendicularly below the connectors to which said end cords are connected; and
a third attached state in which said motor vehicle luggage net is folded in half along the position of said middle cord and attached upright with a forward inclination with said end cords connected to connectors in the side walls of said motor vehicle and said connectors at the two ends of said middle cord connected to connectors that are provided at positions in the vicinity of the floor of said motor vehicle that are toward the rear of said motor vehicle from positions that are perpendicularly below the connectors to which said end cords are connected.

7. An attachment method according to claim 6, wherein:
a plurality of said connectors of said middle cord are provided along the longitudinal direction at each end of said middle cord; and
the distance between the connectors of said motor vehicle to which said end cords are connected and the connectors of said motor vehicle to which said middle cord is connected is different for said second attached state and said third attached state.
